(19) United States
(12) Patent Application Publication
(10) Pub. No.: US 2002/0175299 A1
(43) Pub. Date: Nov. 28, 2002

(54) Ultraviolet irradiation apparatus and method of forming cured coating film using the apparatus

(75) Inventors: Takashi Kanie, Tsushima-shi (JP); Nobuo Yamamura, Tsushima-shi (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: GEN Maintenance Technology Inc., Tsushima-shi (JP)

(21) Appl. No.: 10/097,771

(22) Filed: Mar. 14, 2002

(30) Foreign Application Priority Data
Mar. 14, 2001 (JP) 072686/2001
Mar. 19, 2001 (JP) 079336/2001
Dec. 27, 2001 (JP) 398486/2001
Dec. 28, 2001 (JP) 400816/2001

(51) Int. Cl. G01J 1/00

(52) U.S. Cl. 250/504 R

(57) ABSTRACT

An ultraviolet irradiation apparatus for curing an ultraviolet curable coating agent applied to a substrate, by irradiating an ultraviolet light to the ultraviolet curable coating agent, which includes a low-pressure mercury lamp as a light source. According to the present invention, the problems associated with the use of an ultraviolet irradiation apparatus, whose light source is a high-pressure mercury lamp, can be solved, such as the need of a high voltage power source, degradation of quality, potential hazard to operators and the like. The present invention also provides a method of forming a cured coating film having the same properties as achieved by the use of a high-pressure mercury lamp, such as resistance to stain, adhesion to substrate and the like. This method requires a shorter time for curing of a unit area of the film as compared to the use of a high-pressure mercury lamp (100 V type). Accordingly, the present invention is particularly useful for floor surfaces of gymnasiums, classrooms, department stores, offices, stores, showrooms and the like.

### TECHNICAL FIELD OF THE INVENTION

The present invention relates to an ultraviolet irradiation apparatus (particularly, moveable ultraviolet irradiation apparatus) used for UV irradiation of floors of a building, such as gymnasium, classroom, department store, office, store, showroom, house and the like, for the purpose of curing an ultraviolet curable coating agent applied at the worksite.

More particularly, the present invention relates to a method for forming a cured coating film using the ultraviolet irradiation apparatus.

### BACKGROUND OF THE INVENTION

A coating film made from an ultraviolet curable coating agent is mainly cured using an ultraviolet irradiation apparatus using a high-pressure mercury lamp and/or middle-pressure mercury lamp having a high calorific value as a light source Particularly for the application at work site, a moveable ultraviolet irradiation apparatus having a high-pressure mercury lamp and/or a middle-pressure mercury lamp as a light source has been used.

The moveable ultraviolet irradiation apparatus basically has a power source section equipped with wheels, and a light source section electrically connected to the power source Section to emit ultraviolet light in response to a power supply from the power source section. In conventional moveable ultraviolet irradiation apparatuses, a high-pressure mercury lamp and/or a middle-pressure mercury lamp are/is generally used as a light source section, because these lamps provide superior work efficiency, as evidenced by high moving speed of the apparatus realized by the short time necessary for curing a coating agent, increased irradiation width of ultraviolet light and the like.

When the above-mentioned high-pressure mercury lamp and/or middle-pressure mercury lamp are/is used as a light source, however, a greater input power is required than does the use of a low-pressure mercury lamp and the like. In the conventional moveable ultraviolet irradiation apparatuses, the use of a typical 100V single-phase alternating current (AC) power source makes work time longer, because it limits the size and number of the lamp, thereby restricting the moving speed of the apparatus and allowing irradiation of only a small area. To avoid such problems, a 200V three-phase AC power source has been generally used.

The 200V three-phase AC power source, nevertheless, is set in specific sites, such as the basement floor of a building and the like, and a 100V single-phase AC power source is normally installed on each floor. This in turn means that coating on each floor of a building using an ultraviolet curable coating agent requires bringing a power source of a moveable ultraviolet irradiation apparatus up from, for example, the basement floor. When a 200v three-phase AC power source is used, therefore, the work site and the power source may be located far from each other. Since these two need to be connected electrically with a long power cord, the workability becomes poor.

Moreover, since a conventional moveable ultraviolet irradiation apparatus requires a high power as mentioned above, the temperature of the light source becomes considerably high, which in turn induces high thermal radiation during the use of ultraviolet light. When the above-mentioned coating is applied to a floor material made from a resin having generally low heat resistance, such as vinyl chloride resin, polyolefin resin, polyester resin and the like, the heat sometimes burns the floor surface, causes thermal deformation (twist, bend, warp etc.) of the floor material and/or coating film and produces cracks etc., easily degrading the quality. To solve these problems, a cold mirror may be used for the apparatus and the cooling method of the apparatus may be devised, but these approaches would make the apparatus expensive. In addition, the worker using the apparatus is at risk of injury, because the worker may inadvertently touch the light source section during or immediately after UV irradiation and get burnt.

Conventional moveable ultraviolet irradiation apparatuses are also inconvenient in that the apparatus as a whole becomes bulky and heavy, because it requires a large capacitance, making the power source section bigger. The detachment/attachment of a high voltage electric cord is generally unpreferable from the safety aspect. Thus, the power source section and the light source section should be constantly kept in electrical connection, which makes transport etc. of the apparatus difficult.

When a low-pressure mercury lamp is used as a light source, the coating film may not be sufficiently cured. Thus, curing to a sufficient level may take longer than when a 200V high-pressure mercury lamp is used as a light source. On the contrary, a low-pressure mercury lamp does not require a high voltage power source, because the necessary capacitance is not so high as that for a high-pressure mercury lamp. Furthermore, since a low-pressure mercury lamp emits only a small amount of heat, it is safe for the operator. Even if irradiation is applied longer than the predetermined time, the lamp does not burn the substrate and/or coating film, does not cause deformation (twist, bend, warp etc.) and does not produce cracks etc. Consequently, a low-pressure mercury lamp does not easily cause degradation of the quality.

### SUMMARY OF THE INVENTION

It is therefore an object of the present invention to provide an ultraviolet irradiation apparatus (particularly a moveable ultraviolet irradiation apparatus) that uses only a smaller input power than before, is capable of improving workability and safety and that permits miniaturization and light weight apparatus.

Another object of the present invention is to solve the problems associated with the use of an ultraviolet irradiation apparatus, whose light source is a high-pressure mercury lamp, such as the need of a high voltage power source, degradation of quality, potential hazard to operators and the like, and provide a method of forming a cured coating film having the same properties as achieved by the use of a high-pressure mercury lamp, such as resistance to stain, adhesion to substrate and the like, and requiring a shorter time for curing of a unit area of the film as compared to the use of a high-pressure mercury lamp (100 V type).

The present inventors have found that a cured coating film obtained by applying an ultraviolet curable coating agent containing a photopolymerization initiator and a photopolymerizable resin containing a urethane(meth)acrylate resin to a substrate and irradiating the agent with ultraviolet light using an ultraviolet irradiation apparatus, whose light source is a low-pressure mercury lamp, to cure the coating film is free of problems associated with the use of an ultraviolet irradiation apparatus, whose light source is a high-pressure mercury lamp, such as the need of a high voltage power source, degradation of quality, potential hazard to operators and the like, has the same properties as achieved by the use of a high-pressure mercury lamp, such as resistance to stain, adhesion to substrate and the like, and requires a shorter time for curing of a unit area of the film as compared to the use of a high-pressure mercury lamp (100 V type), which led to the completion of the present invention.

During UV irradiation of a coating film, the ultraviolet light may leak from an ultraviolet irradiation apparatus. However, the amount of the leaked ultraviolet light is not sufficient to cure the coating film. Thus, the area exposed to the leaked ultraviolet light is insufficiently irradiated with UV. This UV insufficient area and the area exposed to a sufficient amount of ultraviolet light for curing of the coating film (UV irradiation area) are located near. As a result, defects of coating film occur, such as appearance of patterns of tortoise shell (hereinafter to be referred to as Tortoiseshell Pattern), crepe pattern (hereinafter to be referred to as Wrinkle), fine concavoconvex pattern (hereinafter to be referred to as Fog) and the like. To solve this problem, the present invention proposes use of a urethane(meth)acrylate resin as an ultraviolet curable coating agent, which is obtained by urethane reaction using an aluminum compound as a catalysts or application of plural cycles of UV irradiation, within a given length of time, of a coating film having a UV insufficient area produced by irradiation of leaked UV light, thereby providing a superior effect of suppressing the occurrence of defects of coating film, such as Tortoiseshell Pattern, Wrinkle, Fog and the like.

Accordingly, the present invention provides the following 1) to 21).

1) An ultraviolet irradiation apparatus for curing an ultraviolet curable coating agent applied on a substrate by irradiating an ultraviolet light to the ultraviolet curable coating agent, comprising a low-pressure mercury lamp as a light source.

2) The ultraviolet irradiation apparatus of the above-mentioned 1) which comprises a power source section equipped with a wheel, and a light source section electrically connected to the power source section that emits an ultraviolet light upon supply of electricity from the power source section

3) The ultraviolet irradiation apparatus of the above-mentioned 2), wherein the power source section is supplied with an input voltage of less than 200 V and an input current of not more than 20 A.

4) The ultraviolet irradiation apparatus of the above-mentioned 2), wherein the low-pressure mercury lamp has an input power per unit size of not less than 1 W/cm.

5) The ultraviolet irradiation apparatus of the above-mentioned 2), wherein the light source section and the power source section are electrically connected with a detachable electric cord.

6) The ultraviolet irradiation apparatus of the above-mentioned 5), wherein the light source section can be placed on the power source section.

7) The ultraviolet irradiation apparatus of the above-mentioned 2), which further comprises, in addition to the above-mentioned light source section comprising a low-pressure mercury lamp as a light source, a second light source section that emits an ultraviolet light having a dominant wavelength of not less than 320 nm as a light source, said second light source section is disposed such that the ultraviolet light having a wavelength of not less than 320 nm reaches the ultraviolet curable coating agent after arrival of the ultraviolet light from the above-mentioned low-pressure mercury lamp.

8) The ultraviolet irradiation apparatus of the above-mentioned 7), wherein the ultraviolet light source having a dominant wavelength of not less than 320 nm is disposed on both sides of the light source section.

9) The ultraviolet irradiation apparatus of the above-mentioned 7), wherein the light source having a dominant wavelength of not less than 320 nm is disposed at an upper side or in front of the low-pressure mercury lamp on a forward end of the light source section.

10) A method of forming a cured coating film, comprising the steps of

(a) coating a substrate with an ultraviolet curable coating agent comprising a photopolymerization initiator and a photopolymerizable resin comprising a urethane(meth)acrylate resin, and

(b) irradiating an ultraviolet light using the ultraviolet irradiation apparatus of the above-mentioned 1), to cure the coating film.

11) The method of forming the cured coating film according to the above-mentioned 10), wherein the urethane(meth)acrylate resin is produced by a urethane reaction using an aluminum compound as a catalyst.

12) The method of forming the cured coating film according to the above-mentioned 10), wherein the ultraviolet curable coating agent is applied to a substrate such that the film has a thickness after curing of not less than 4 μm and not more than 70 μm.

13) The method of forming the cured coating film according to the above-mentioned 10), wherein the ultraviolet curable coating agent is applied to a substrate such that the film has a thickness after curing of not less than 7 μm and not more than 70 μm.

14) The method of forming the cured coating film according to the above-mentioned 10), wherein the ultraviolet curable coating agent is applied to a substrate after application of a primer thereto.

15) The method of forming the cured coating film according to the above-mentioned 10), wherein the ultraviolet curable coating agent is aqueous.

16) The method of forming the cured coating film according to the above-mentioned 10), wherein the ultraviolet curable coating agent is applied to a floor surface, after which the ultraviolet light is irradiated thereon using the ultraviolet irradiation apparatus of claim 2 to cure the coating agent.

17) The method of forming the cured coating film according to the above-mentioned 10), further comprising plural times of UV irradiation of a coating film having a UV insufficient area produced by the UV irradiation, using a moveable ultraviolet irradiation apparatus.

18) The method of forming the cured coating film according to the above-mentioned 17), wherein the UV irradiation is applied within 15 minutes from a previous UV irradiation.

19) The method of forming the cured coating film according to the above-mentioned 17), wherein the UV irradiation is applied within 5 minutes from a previous UV irradiation.

20) A urethane(meth)acrylate resin obtained by reacting an isocyanate compound and a hydroxyl compound using an aluminum compound as a catalyst.

21) An ultraviolet curable coating agent comprising the urethane(meth)acrylate resin of the above-mentioned 20).

### BRIEF DESCRIPTION OF THE DRAWINGS

FIG. 1 is a simplified side view of a preferable first embodiment of the moveable ultraviolet irradiation apparatus 1 of the present invention.

FIG. 2 is a top view of the moveable ultraviolet irradiation apparatus 1 of FIG. 1.

FIG. 3 is a simplified side view of a moveable ultraviolet irradiation apparatus 1 during transport without irradiation of ultraviolet light.

FIG. 4 is a simplified side view of a preferable second embodiment of the moveable ultraviolet irradiation apparatus 21 of the present invention.

FIG. 5 is a top view of the moveable ultraviolet irradiation apparatus 21 of FIG. 4.

FIG. 6 is a simplified cross-sectional view of a handy type light source section 31 of the present invention. In the Figure, 1 is a moveable ultraviolet irradiation apparatus, 2 is a power source section and 3 is a light source section.

### DETAILED DESCRIPTION OF THE INVENTION

The present invention is explained in detail in the following.

In the present specification, by the “UV irradiation area” is meant “a coating film exposed to ultraviolet light in an amount sufficient for curing the coating film (UV irradiation quantity of preferably not less than 60 mJ/cm², more preferably not less than 150 mJ/cm²)”, by the “UV insufficient area” is meant “a coating film exposed to ultraviolet light in an amount exceeding normally irradiated ultraviolet light but insufficient to cure a coating film”, and by the “UV unirradiation area” is meant “a coating film free of ultraviolet light irradiation, which is optionally exposed to ultraviolet light at a normal level (e.g., sunshine etc.)”.

1. Ultraviolet Irradiation Apparatus

The ultraviolet irradiation apparatus of the present invention is characterized by the light source which is a low-pressure mercury lamp.

Generally, a mercury lamp emits light by electrical discharge in mercury vapor. Those having an internal pressure of not more than 1 mmHg are referred to as low-pressure mercury lamp, wherein most part of the optical energy are concentrated around 254 nm (253 nm-255 nm, particularly 253.7 nm), and used for a fluorescent lamp a germicidal lamp and the like (Iwanami Rikagakujiten, 1998, p. 683).

The low-pressure mercury lamp in the present invention means the same as for the above-mentioned definition. As long as it emits ultraviolet light at 253.7 nm (254 nm), it is free of any particular limitation as to its shape, size and the like. Specific examples include QGL-100-2X (IWASAKI ELECTRIC Co., Ltd.) and the like. In view of curing property of a coating film, a higher output type lamp is preferable.

The low-pressure mercury lamp has a lower calorific value than does a high-pressure mercury lamp. It has a low risk of burning an operator who inadvertently touched the lamp immediately after UV irradiation. In addition, it requires smaller capacitance and a typical 100V power source can be used for at site application, with sufficient curability. An ultraviolet irradiation apparatus using a low-pressure mercury lamp as a light source provides various advantages in that a cooling system (fan and insulating board) can be made smaller than that for an apparatus using a high-pressure mercury lamp as a light source. As a result, the ultraviolet irradiation apparatus as a whole becomes light weight and its work efficiency can be improved.

As an ultraviolet irradiation apparatus, for example, a known moveable ultraviolet irradiation apparatus disclosed in U.S. Pat. No. 6,096,383, JP-B-2588100 and the like. The moveable ultraviolet irradiation apparatus to be explained in detail in the following is preferably used.

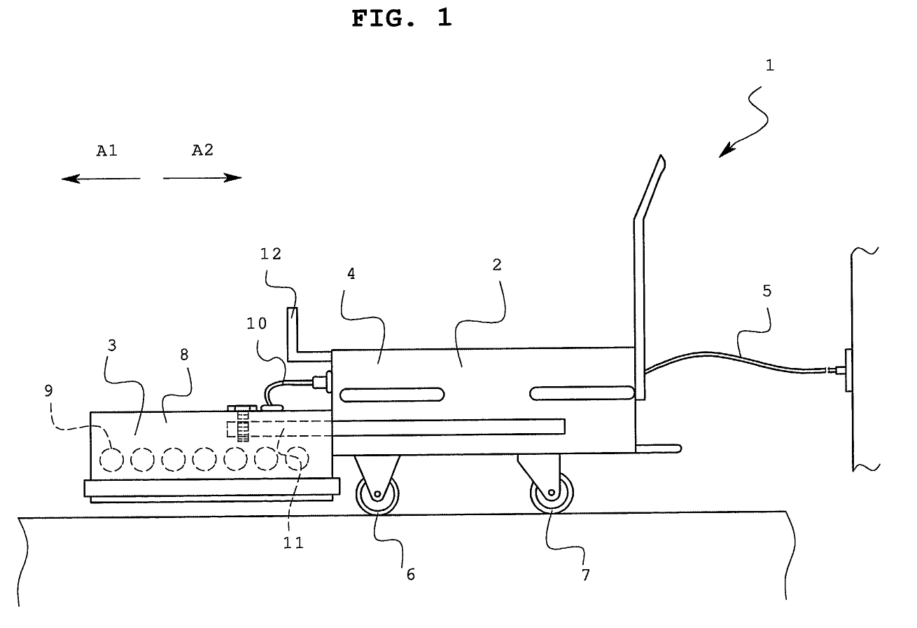

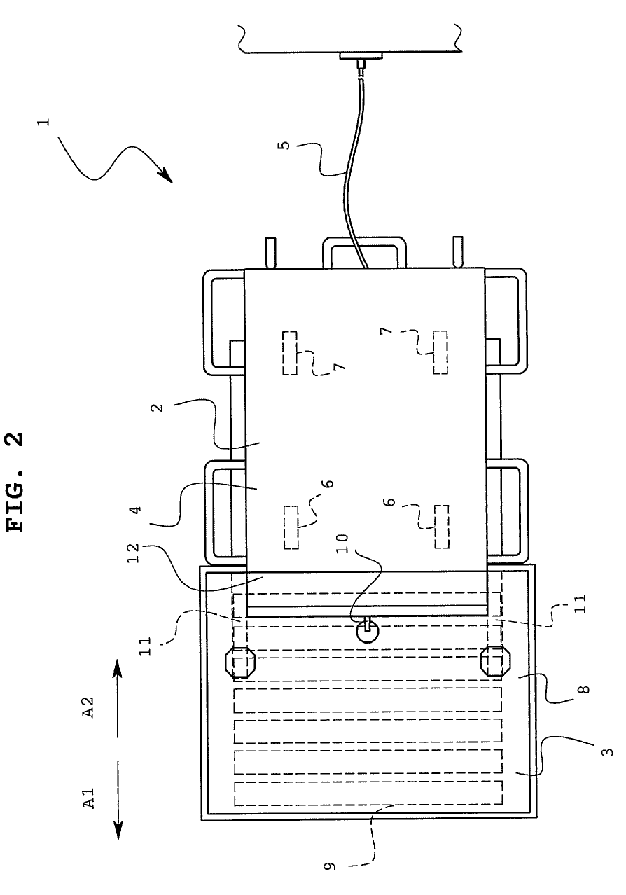

FIG. 1 is a simplified side view of a preferable first embodiment of the moveable ultraviolet irradiation apparatus 1 of the present invention and FIG. 2 is a top view of the moveable ultraviolet irradiation apparatus 1 of FIG. 1. In FIG. 1 and FIG. 2, the moveable ultraviolet irradiation apparatus 1 can emit ultraviolet light. The moveable ultraviolet irradiation apparatus 1 of the present invention is an apparatus for forming a cured coating film on a floor surface by irradiating ultraviolet light on the upper surface of an ultraviolet curable coating agent applied on the floor surface. The apparatus basically comprises a power source section 2 equipped with a wheel, and a light source section 3 electrically connected to the power source section 2 and emits ultraviolet light upon supply of power from the power source section 2. In the present specification, the forward direction Al means the side on which light source section 3 of the moveable ultraviolet irradiation apparatus 1 is disposed in a state allowing irradiation of the ultraviolet light, and the backward direction A2 means the opposite side from the forward direction A1.

The power source section 2 has a box housing 4 and the housing 4 contains a stabilizer (not shown) and a controller (not shown). The power source section 2 may have, as shown in FIG. 1, a power cord 5 to obtain power from a consent and the like as a power source. Alternatively, a power source section such as a battery may be installed inside the housing.

The power source section 2 comprises a wheel, specifically a front wheel 6 to be set on the forward direction side near a lower end of housing 4, and a rear wheel 7 to be set on the backward direction side near the lower end of the housing 4. In the embodiment shown in FIG. 1, the front wheel 6 and rear wheel 7 each consists of, but not limited to, two wheels. Either wheel may consist of a single wheel. Because the front wheel 6 and rear wheel 7 are set on a power source section 2, they do not step on the uncured ultraviolet curable coating agent coated on a floor surface when irradiating ultraviolet light while moving. To be specific, the moveable ultraviolet irradiation apparatus 1 generally moves in the direction toward the side where the light source section 3 is set, while emitting the ultraviolet light. The wheels always follow the path where the light source section 3 passed. As a result, the wheel always steps on the coating film cured by UV irradiation of the ultraviolet curable coating agent, without stepping on the uncured ultraviolet curable coating agent. With the above-mentioned front wheel 6 and rear wheel 7, the moveable ultraviolet irradiation apparatus 1 is constituted to secure a smooth movement back and forth.

The light source section 3 is electrically connected to the above-mentioned power source section 2, and emits ultraviolet light upon provision of electricity from the power source section 2. In the embodiment shown in FIG. 1 and FIG. 2, the light source section 3 comprises a box cover (lamp housing) 8 having an opening to pass the light and a light source (lamp) 9 housed in the cover 8.

The important aspect of the present invention is the use of the above-mentioned low-pressure mercury lamp as a light source to cure an ultraviolet curable coating agent applied to a floor surface by irradiation of ultraviolet light. The low-pressure mercury lamp has never been used conventionally as a light source of a moveable ultraviolet irradiation apparatus.

The moveable ultraviolet irradiation apparatus 1 of the present invention, which uses a low-pressure mercury lamp as a light source 9, can decrease the power necessary for input into power source section 2, as compared to the use of a high-pressure mercury lamp or middle-pressure mercury lamp as a light source. In the present invention, therefore, a moveable ultraviolet irradiation apparatus can be realized, wherein the input voltage of power source section is less than 200V, and the input current is not more than 20A. In addition, using a general 100V single-phase AC power source (receptacle of about 100V·15A) as a power source, a moveable ultraviolet irradiation apparatus can be realized. Unlike the conventional cases where a power sources of a 200V three-phase AC is essential, a power source is available in each in site application, when, for example, the floor of each floor in a building is to be coated with an ultraviolet curable coating agent and the like, thereby improving workability.

In the present invention, a low-pressure mercury lamp is used as a light source, as result of which calorific value at the light source section due to irradiation of ultraviolet light be decreased to the same level as that of fluorescent lamp. Therefore, unlike the conventional cases where a high-pressure mercury lamp and middle-pressure mercury lamp are used as light sources, even when an operator inadvertently touched the light source section 3 during UV irradiation or immediately after UV irradiation, the operator is not burnt and free of such risk. Furthermore, even when a floor material generally having low heat resistance is to be coated, burning of the floor surface, thermal deformation (twist, bend, warp etc.) of a floor material and the like do not occur.

The use of a low-pressure mercury lamp as a light source 9 decreases the power to a level necessary for a fluorescent lamp Therefore, the power source section 2 can be a miniaturized and light weight apparatus, as compared to a conventional moveable ultraviolet irradiation apparatus. Consequently, the ultraviolet irradiation apparatus 1 as a whole can be made into a miniaturized and light-weight apparatus as compared to conventional apparatuses.

When a high-pressure mercury lamp is used as a light source, as in the conventional ones, about 2 minutes to 6 minutes is necessary after switching on of the power source section until the luminance of the light source reaches a given level to irradiate ultraviolet light. In the present invention, however, since a low-pressure mercury lamp is used as a light source, ultraviolet light can be irradiated within a few seconds after switching on of the power source section. Because the time necessary before irradiation of the ultraviolet light after supply of power to the light source section can be shortened as compared to conventional apparatuses, which in turn improves workability.

The low-pressure mercury lamp to be used in the present invention preferably shows an input power per unit size (input power per length of light emitted from light source) of not less than 1 W/cm. When the input power per unit size is less than 1 W/cm, the time necessary for the ultraviolet curable coating agent to be sufficiently cured after irradiation of ultraviolet light on the ultraviolet curable coating agent applied to the floor surface is too long, thereby unpreferably degrading the workability. By the use of a low-pressure mercury lamp having an input power per unit size of not less than 1 W/cm, the ultraviolet curable coating agent can be sufficiently cured in about a few seconds after irradiation of ultraviolet light, affording efficient coating of a substrate.

In the present invention, the method of setting a low-pressure mercury lamp is not particularly limited. When a straight type low-pressure mercury lamp is used, it may be set in the longitudinal direction (about parallel to the backward and forward direction) or transverse direction (about perpendicular to the backward and forward direction), or when a curved low-pressure mercury lamp is used as shown in U.S. Pat. No. 6,207,118,B1, it may be set in an optional direction.

FIG. 1 and FIG. 2 show an embodiment of a moveable ultraviolet irradiation apparatus 1, wherein seven low-pressure mercury lamps (QGL-100-2X, IWASAKI ELECTRIC CO., LTD.), each having an effective emission length (length in the longitudinal direction of lamp) of 64 cm and an input power of 100 W (input power per unit size: about 1.5 W/cm) are transversely arranged (about perpendicular to the backward and forward direction) to give a light source 9, with which a light source section 3 is realized. When, in such a case, ultraviolet light is irradiated on the floor surface using a moveable ultraviolet irradiation apparatus 1, the UV irradiation intensity (measured using irradiation intensity meter (UVP254, IWASAKI ELECTRIC CO., LTD.) on the floor surface was 4.3 mw/cm² (254 nm intensity) at 3.5 cm inside the cover from the side of the cover, and 0.8 mW/cm² (254 nm intensity) at 3.5 cm outside the cover from the side of the cover. Using an ultraviolet irradiation apparatus 1 having a light source section 3 mounted as mentioned above, for example, ultraviolet light is irradiated on an ultraviolet curable coating agent containing a urethane(meth)acrylate resin to be mentioned below, so that the thickness of the cured coating film would be 15 μm. As a result, the curing rate of about 6 /m/min can be achieved, even if the input power is less than 100V·15A (in the above case, substantial cure width is about 80 cm).

In the moveable ultraviolet irradiation apparatus 1, a power source section 2 and a light source section 3 are electrically connected by a detachable electric cord 10. In the present invention, conventional high voltage is not transmitted from the power source section 2 to light source section 3. When the ultraviolet light is not irradiated (e.g., during transport to application site, during preservation and the like), therefore, electric cord 10 can be pulled out from power source section 2 and light source section 3, without causing any safety problem. In the present invention, therefore, when the above-mentioned ultraviolet light is not irradiated, electric cord 10 can be pulled out, power source section 2 and the light source section 3 can be separated and the light source section 3 can be placed on the power source section 2.

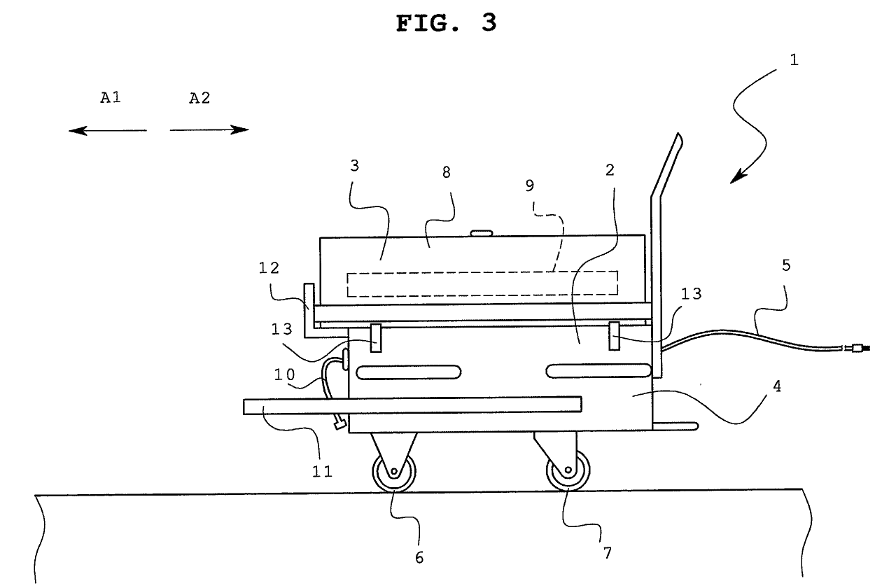

For example, in the moveable ultraviolet irradiation apparatus 1 as shown in FIG. 1, which can irradiate ultraviolet light, a supporting member 11 fixed on the side wall of a housing 4 of power source section 2 is inserted in a cover 8 to support the upper wall of the cover 8 from the inside, a bolt screw is inserted from the upper wall of the cover 8 until it reaches the supporting member 11, thereby to fix the cover 8 and the supporting member 11. In this way, the light source section 3 is connected to the front of the power source section 2, at 1 cm-6 cm distant from the floor surface. FIG. 3 is a simplified side view of the moveable ultraviolet irradiation apparatus 1 when ultraviolet light is not irradiated. In the embodiment of FIG. 3, the ultraviolet light that can be irradiated in FIG. 1 and FIG. 2 has been made to be otherwise by turning off the power switch (not shown) etc., then electric cord 10 that electrically connects the power source section 2 and the light source section 3 is pulled out, the light source section 3 is separated from the power source section 2, and the light source section 3 is placed on the power source section 2.

As shown, it is possible to separate the power source section 2 from the light source section 3 in the moveable ultraviolet irradiation apparatus 1 of the present invention, after prohibiting the irradiation of ultraviolet light. The separated light source section 3 is placed on the power source section 2. As a result, the projected area on the floor (the area of the entire apparatus, seen from the top as in FIG. 2) can be made smaller, as compared to conventional moveable ultraviolet irradiation apparatuses wherein a power source section and a light source section are difficult to separate. Therefore, it can be transported on a compact vehicle, such as a delivery van and the like, on which conventional moveable ultraviolet irradiation apparatuses cannot be carried.

By placing a light source section 3 on a power source section 2, the upper face of the housing 4 of the power source section 2 can block the opening made in the cover of light source section 3 for passing the ultraviolet light. As a result, the light source 9 can be blocked from the outside, thereby preventing the light source from being stained or getting broken.

In the case of FIG. 3, the light source section 3 is turned 90 degrees and placed on the power source section 2. The support 12 formed on the upper part in the forward direction of the power source section 2 supports the portion of the light source section 3, which extruded from the power source section 2. In this state, for example, a lock 13 is set to fix the light source section 3 on the power source section 2 which facilitates transport and the like.

It is also possible to adhere a vibration resistant rubber on the periphery of the upper face of the power source section 2. This has an effect that the vibration transmitted to a light source 9 during the transport of the ultraviolet irradiation apparatus 1, wherein the light source section 3 is placed on the power source section 2, can be decreased.

As described above, the use of a low-pressure mercury lamp as a light source according to the present invention can solve all the problems found with conventional ultraviolet irradiation apparatuses that use a high-pressure mercury lamp alone as a light source. The conditions of UV irradiation with a low-pressure mercury lamp may vary depending on the kind of the ultraviolet curable coating agent (composition), selection of coating conditions, and thickness of the layer of the ultraviolet curable coating agent applied to a floor surface. When the light source is a low-pressure mercury lamp alone, the obtained cured coating film may contain defects such as Tortoiseshell Pattern, Wrinkle, Fog and the like, depending on the composition of coating agent, structure of light source section, irradiation conditions of ultraviolet light, irradiation site and the like. The present invention is free of such defects of the film as long as the amount of irradiation is sufficient, because an ultraviolet curable coating agent is cured by the irradiation of ultraviolet light having a short wavelength of about 254 nm, which is derived from a low-pressure mercury lamp showing a low irradiation amount and low intensity. However, only the surface and the vicinity of the surface of a coating film is cured in a relatively short time in the area where ultraviolet light is not sufficiently irradiated (UV insufficient area). The extremely thin cured portion shrinks upon curing, thus producing the defects of the coating film as mentioned above (which of the above-mentioned Tortoiseshell Pattern, Wrinkle and Fog would occur depends on various conditions relating to curing and shrinkage). Particularly, the coating agent away from the light source section is exposed to an undesired irradiation of ultraviolet light leaking from the cover of the light source section, where the intensity of the ultraviolet light is considerably low. In such area (UV insufficient area), the above-mentioned defects of coating film tend to occur easily. As a result, the irradiation amount of ultraviolet light (=intensity of ultraviolet light x irradiation time) becomes small, which in turn may cause the above-mentioned defects of coating film, even when the coating agent is directly under the light source section. The defects of coating film can be prevented by appropriately setting the various conditions of the coating agent, moving rate (irradiation rate) of the ultraviolet irradiation apparatus, re-irradiation and the like However, when the floor surface to be irradiated is narrow or has a complicated shape, appropriate operation of ultraviolet irradiation apparatus according to the above-mentioned setting tends to be difficult.

The present inventors have further studied the moveable ultraviolet irradiation apparatus of the present invention. As a result, they have surprisingly found that, by superposing ultraviolet light having a long wavelength, which is emitted from a second light source section having a dominant wavelength of not less than 320 nm as a light source in addition to the ultraviolet light having a short wavelength emitted from a low-pressure mercury lamp, the above-mentioned defects of coating film can be certainly prevented. As used herein, the radiation source of the ultraviolet light having a dominant wavelength of not less than 320 nm is a high-pressure mercury lamp, a metal halide lamp, a black light (black lamp), a black-blue light (black-blue lamp) and the like. The black light is a low-pressure mercury lamp (germicidal lamp and the like), which releases ultraviolet light having a short wavelength (254 nm), permits change of light emission wavelength band to 320 nm-400 nm ultraviolet light by adhering a fluorescent material to the glass surface inside the lamp, and which has a lower output as compared to general high-pressure mercury lamps. Hereinafter, high-pressure mercury lamp and black light are used for further explanation as the examples of the radiation source of at least these ultraviolet lights having a dominant wavelength of not less than 320 nm. It is needless to say that the embodiments of the invention are not limited to these. According to the present invention ultraviolet light derived from a high-pressure mercury lamp and/or a black light are/is superposed on the ultraviolet light derived from a low-pressure mercury lamp, thereby ensuring that, even if irradiation of the ultraviolet light derived from a low-pressure mercury lamp is insufficient and a thin cured part is formed on the surface of a coating film, the ultraviolet light derived from the high-pressure mercury lamp and/or the black light are/is irradiated to achieve sufficient curing of the part other than the surface of the coating film, whereby the defects of coating film can be surely prevented as mentioned above.

Therefore, the moveable ultraviolet irradiation apparatus of the present invention preferably has, in addition to the light source section of the above-mentioned low-pressure mercury lamp, a second light source section which is a high-pressure mercury lamp and/or a black light By this constitution, a moveable ultraviolet irradiation apparatus can be realized, which provides an advantage of ensured prevention of occurrence of defects of coating film, in addition to the aforementioned advantages over conventional ultraviolet irradiation apparatuses as using a high-pressure mercury lamp alone as a light source.

With respect to superposition of the ultraviolet light derived from a low-pressure mercury lamp and the ultraviolet light derived from a high-pressure mercury lamp and/or a black light, when the ultraviolet light derived from a high-pressure mercury lamp reaches the coating agent earlier than or at the same time as the ultraviolet light derived from the low-pressure mercury lamp, the amount of the ultraviolet light derived from the high-pressure mercury lamp and/or the black light, which is sufficient to cure the coating agent, makes the cured coating film too stiff, and causes easy occurrence of cracks and the like, as well as the defects of cured coating film, such as peeling of coating film from a floor material and the like. For irradiation of ultraviolet light to cure ultraviolet curable coating agent applied on a floor surface, by the use of an ultraviolet irradiation apparatus equipped with the above-mentioned second light source section, it is important that ultraviolet light derived from the low-pressure mercury lamp be first irradiated, and the amount of the ultraviolet light derived from the high-pressure mercury lamp and/or the black light be adjusted upon irradiation.

The second light source section, which comprises a high-pressure mercury lamp and/or a black light, is subject to no particular limitation as to the manner of its setting, as long as the ultraviolet light from the above-mentioned low-pressure mercury lamp first reaches the ultraviolet curable coating agent and the ultraviolet light from the high-pressure mercury lamp and/or black light reaches next.

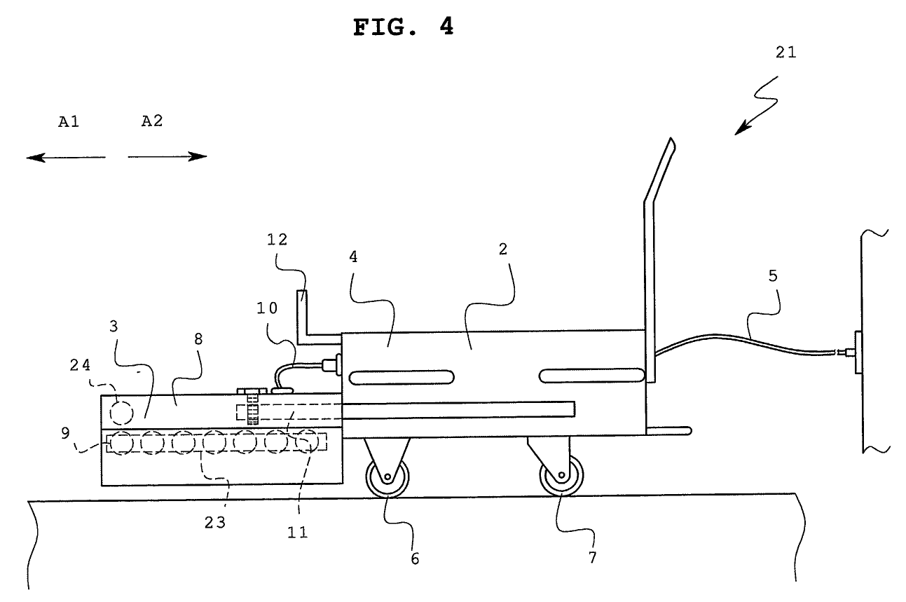

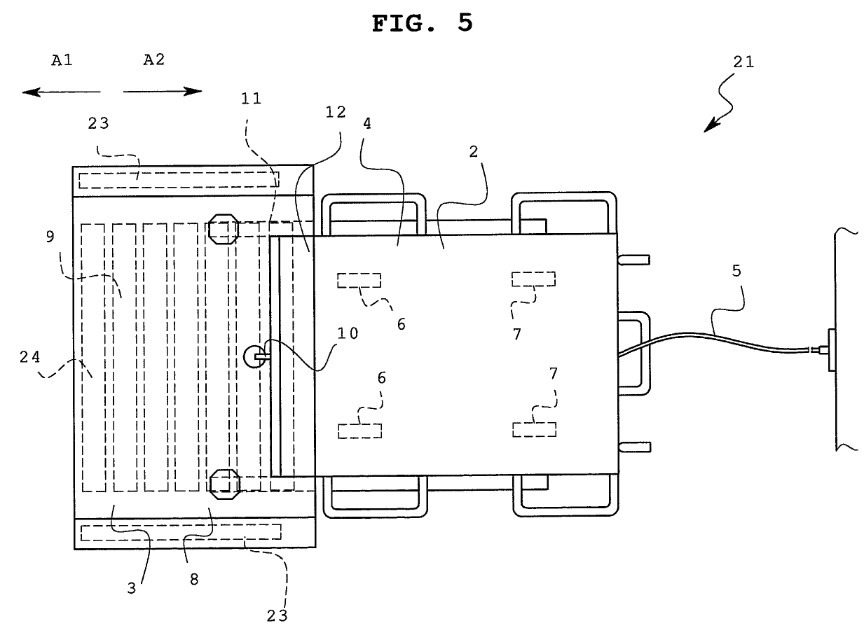

FIG. 4 is a simplified side view of a preferable second embodiment of the moveable ultraviolet irradiation apparatus 21 of the present invention. FIG. 5 is a top view thereof. the moveable ultraviolet irradiation apparatus 21 of the embodiment shown in FIG. 4 and FIG. 5 is the same as the moveable ultraviolet irradiation apparatus 1 shown in FIG. 1-FIG. 3, except that a second light source section is further installed, wherein the like parts are shown with like symbols and explanation is omitted.

The ultraviolet irradiation apparatus 21 shown in FIG. 4 and FIG. 5 comprises a high-pressure mercury lamp and a black light 23, 24 on both sides of the light source section 3 and at the upper side of the low-pressure mercury lamp on the forward end of the section 3, thereby realizing a second light source section. An ultraviolet irradiation apparatus comprising a second light source section consisting of such high-pressure mercury lamp and/or black light is capable of ensuring that ultraviolet light from the above-mentioned low-pressure mercury lamp reaches the ultraviolet curable coating agent first and then ultraviolet light from the high-pressure mercury lamp and/or black light reaches, thereby certainly preventing the above-mentioned defects of a coating film.

The second light source may be realized with the high-pressure mercury lamps or black lights 23 alone set on both sides of the light source section 3 or with high-pressure mercury lamp or black light 24 alone set at the upper side of the low-pressure mercury lamp 9. As shown in FIG. 4 and FIG. 5, the second light source section consisting of high-pressure mercury lamps or black lights 23, 24 set on both parts is particularly preferable, because it ensures prevention of the above-mentioned defects of coating film. Even when there occurs a need to terminate the irradiation work using the ultraviolet irradiation apparatus on the way and turn back the apparatus as is, moreover, the coating agent in front of the light source section can be irradiated with not only UV light from the low-pressure mercury lamp, but the UV light from the high-pressure mercury lamp or black light. Consequently, occurrence of the above-mentioned defects of coating film can be particularly preferably prevented.

The above-mentioned second light source section may consist of a high-pressure mercury lamp or black light disposed in front of the low-pressure mercury lamp on the forward end of the light source section, instead of the high-pressure mercury lamp or black light disposed at the upper side of the low-pressure mercury lamp on the forward end of the light source section. When a high-pressure mercury lamp 24 is additionally disposed at the upper side or in front of the low-pressure mercury lamp 9 on the forward end of the above-mentioned light source section 3, long wavelength ultraviolet light may be superposed during the initial stage of the irradiation of short wavelength ultraviolet light and the irradiation time of ultraviolet light derived from the high-pressure mercury lamp and/or black light may be made the same as or shorter than the irradiation time of the ultraviolet light derived from the low-pressure mercury lamp.

When a second light source section comprising a high-pressure mercury lamp and/or a black light as a light source is equipped, the kind of the high-pressure mercury lamp and black light is not particularly limited. FIG. 4 and FIG. 5 show an example where a high-pressure mercury lamp (H004-L21, IWASAKI ELECTRIC CO., LTD.) is disposed at the upper side of the low-pressure mercury lamp and a black-blue lamp (FL15BLB, TOSHIBA) is disposed on both sides of the light source. In this case, the high-pressure mercury lamp to be disposed at the upper side or in front of the low-pressure mercury lamp shows a UV irradiation intensity of 2 mW/cm² (365 nm) as measured with an irradiation intensity meter (UVP-301G, EYE GRAPHICS Co. Ltd.) on the floor surface upon irradiation from 43 cm above the floor surface. The UV irradiation intensity as measured with an irradiation intensity meter (UVP-301G, EYE GRAPHICS Co. Ltd.) on the floor surface upon irradiation from 2 cm above the floor surface with a black-blue lamp disposed on both sides of the light source section is 0.5 mW/cm² (365 nm intensity). By setting a black-blue lamp, which has a weak output as compared to a typical high-pressure mercury lamp, on both sides as mentioned above, consumption power can be advantageously reduced.

The moveable ultraviolet irradiation apparatus of the present invention may have any structure as long as it comprises a power source section equipped with wheels, and a light source section electrically connected to the power source section to emit ultraviolet light in response to the power supply from the power source section, and the light source section having a low-pressure mercury lamp as a light source, and is not limited to the structure shown in the embodiment of FIG. 1-FIG. 3.

For example, it may be a handy type ultraviolet irradiation apparatus comprising a power source section equipped with wheels, and a light source section electrically connected to the power source section to emit ultraviolet light in response to the power supply from the power source section, and the light source section having a miniaturized low-pressure mercury lamp. In such handy type UV irradiation, the operator is not restricted by the length of the electric cord connecting the light source section and the power source section, but can continue the irradiation work while pulling the power source section with the light source section in hand, because a power source section is equipped with a wheel.

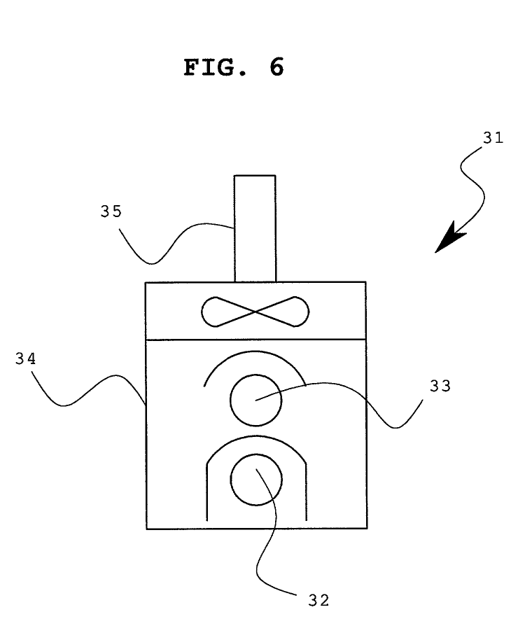

FIG. 6 is a cross section showing a simplified view of the light source section 31 of a handy type apparatus of the present invention. For making a handy type apparatus, a light source (low-pressure mercury lamp 32, high-pressure mercury lamp 33) and a cover 34 should be made smaller than those in the aforementioned embodiments. The cover 34 has a holder part 35 on the opposite side from the opening formed for the passage of the ultraviolet light. By holding this holder part 35, the operator holds only light source section 31 of the moveable ultraviolet irradiation apparatus and proceed with the irradiation work smoothly.

In the embodiment shown in FIG. 6, a high-pressure mercury lamp 33 is disposed at the upper part of the low-pressure mercury lamp 32. In the present invention, the above-mentioned low-pressure mercury lamp and a high-pressure mercury lamp may be combined in a handy type apparatus, or the low-pressure mercury lamp alone may be made a light source for a handy type apparatus.

The present invention also provides a method for curing a coating film by irradiation of ultraviolet light on a specific ultraviolet curable coating agent using the above-mentioned ultraviolet irradiation apparatus wherein a light source consists of a low-pressure mercury lamp. According to this method, the target to form a cured coating film on is not limited to floor materials.

2. Ultraviolet Curable Coating Agent

The ultraviolet curable coating agent in the present invention contains, as a required component, a photopolymerizable resin and a photopolymerization initiator. After applying the coating agent to a substrate, it is exposed to UV light, thereby forming a cured coating film on the surface of the substrate. The ultraviolet curable coating agent of the present invention is a coating film material capable of protecting the surface of a substrate or affording good appearance. For example, it can be used as paints, polish, wax, surface treatment agent and the like.

The photopolymerizable resin and a photopolymerization initiator are explained in the following.

The present inventors have considered using, as a light source of an ultraviolet irradiation apparatus, a low-pressure mercury lamp seldom used for forming a cured coating film so far, in view of the insufficient curing of a coating film achieved thereby and a longer curing time required as compared to the use of a high-pressure mercury lamp as a light source, and found the above-mentioned ultraviolet irradiation apparatus capable of curing an ultraviolet curable coating agent. Furthermore, the present inventors have studied ultraviolet curable coating agents suitable for the ultraviolet irradiation apparatus of the present invention, which is capable of forming, even by the use of a low-pressure mercury lamp as a light source, a cured coating film having similar properties (e.g., stain resistance, adhesion to substrate and the like) to those achieved by the use of a high-pressure mercury lamp, and which requires a shorter curing time per unit area of the coating film than by the use of a high-pressure mercury lamp (100 V type). As a result, they have found that an ultraviolet curable coating agent containing a photopolymerizable resin containing a urethane(meth)acrylate resin is extremely suitable for curing by the use of the above-mentioned ultraviolet irradiation apparatus including a low-pressure mercury lamp as a light source.

In the following, an ultraviolet curable coating agent containing a photopolymerizable resin containing a urethane(meth)acrylate resin is explained, but the ultraviolet curable coating agent to be cured using an ultraviolet irradiation apparatus of the present invention is not limited to the following.

2-1. Photopolymerizable Resin

The photopolymerizable resin in the present invention cures by being exposing to light having a wavelength of 200-800 nm, and preferably contains a urethane(meth)acrylate resin. The urethane(meth)acrylate resin is contained in a proportion of not less than 10 wt %, preferably not less than 50 wt %, of the entire photopolymerizable resin. The photopolymerizable resin in the present invention may contain a resin other than urethane(meth)acrylate resin, as long as the object of the present application is not impaired.

As the rosin other than urethane(meth)acrylate resin, for example, unsaturated polyester resin, epoxy(meth)acrylate resin and the like are mentioned, 1 or more of which may be contained.

As the unsaturated polyester resin in the present invention, for example, acrylate synthesized by the reaction of phthalic anhydride, propylene oxide and acrylic acid; acrylate synthesized by the reaction of adipic acid, 1,6-hexanediol and acrylic acid; acrylate synthesized by the reaction of trimellitic acid, diethylene glycol and acrylic acid; unsaturated polyester consisting of 1,2-propylene glycol, phthalic anhydride and maleic anhydride; unsaturated polyester containing allyl group-containing compound such as trimethylolpropane diallyl ether (TMPDA), trimethylolpropane triallyl ether (TMPTAE), triallyl isocyanate, diallyl phthalate and the like and styrene; and the like are mentioned.

The epoxy(meth)acrylate resin to be used in the present invention is, for example, epoxy acrylate (bisphenol A type) synthesized by the reaction of bisphenol A, epichlorohydrin and acrylic acid, epoxy acrylate (bisphenol S type) synthesized by the reaction of bisphenol S, epichlorohydrin and acrylic acid, epoxy acrylate (bisphenol F type) synthesized by the reaction of bisphenol F, epichlorohydrin and acrylic acid, epoxy acrylate (phenol novolak type) synthesized by the reaction of phenol novolak, epichlorohydrin and acrylic acid, and the like.

The urethane(meth)acrylate resin in the present invention is a resin containing at least one each of (meth)acryloyl group(CH₂═CHC(O)— or CH₂═C(CH₃)C(O)—) and a urethane bond in a molecule, wherein (meth)acryloyl group and urethane bond may be contained in any ratio. The urethane(meth)acrylate resin of the present invention can be generally produced by a method similar to the production of urethane(meth)acrylate. The urethane(meth)acrylate obtained by, for example, (1) urethane reaction of an isocyanate compound and a hydroxyl compound having a (meth)acryloyl group in a molecule, (2) urethane reaction of an isocyanate compound having a (meth)acryloyl group in a molecule and a hydroxyl compound, and the like.

The urethane reaction is generally carried out using dibutyl tin dilaurate (DBTDL) as a catalyst. However, when the present inventors conducted the urethane reaction using an aluminum compound instead of DBTDL, a highly viscous urethane(meth)acrylate resin could be produced, and when ultraviolet light was irradiated to a coating film containing an ultraviolet curable coating agent produced using this, a superior effect of suppression of occurrence of Tortoiseshell Pattern, Wrinkle, Fog and the like found in the boundary between a UV irradiation area and a UV insufficient area and the like could be afforded. While heavy metals such as DBTDL and the like may cause an adverse influence on the environment and human body, by substituting the metal to an aluminum compound, heavy metal that adversely affects the environment and human body can be preferably eliminated.

The urethane(meth)acrylate resin obtained by reacting an isocyanate compound and a hydroxyl compound using an aluminum compound as a catalyst is novel and has the above-mentioned superior properties and is useful as a photopolymerizable resin for an ultraviolet curable coating agent.

The preferable aluminum compound in the present invention is aluminum.

As the above-mentioned isocyanate compound, there are mentioned a monoisocyanate compound, a diisocyanate compound, a polyisocyanate compound and the like, which is preferably a polyisocyanate compound.

The monoisocyanate compound in the present invention is exemplified by an aliphatic monoisocyanate compound, an alicyclic monoisocyanate compound, an aromatic monoisocyanate compound and the like, which is preferably an aliphatic monoisocyanate compound.

The aliphatic moiety of the aliphatic monoisocyanate compound in the present invention is a linear or branched chain saturated hydrocarbon group having preferably 1-36, more preferably 6-16, carbon atoms. Examples of the aliphatic monoisocyanate compound include methyl isocyanate, ethyl isocyanate, n-hexyl isocyanate, 2-ethylhexyl isocyanate, n-heptyl isocyanate, octyl isocyanate, nonyl isocyanate, decyl isocyanate, undecyl isocyanate, dodecyl isocyanate, tridecyl isocyanate, tetradecyl isocyanate, pentadecyl isocyanate, hexadecyl isocyanate, icosyl isocyanate, triacontyl isocyanate and the like, with preference given to n-hexyl isocyanate.

The alicyclic moiety of the alicyclic monoisocyanate compound in the present invention is saturated alicyclic hydrocarbon group having preferably 3-20, more preferably 6-10, carbon atoms. The alicyclic moiety is optionally substituted by one or more substituents as long as the substitution does not impair the object of the present invention. Examples of the substituent include isophoronyl, cyclohexyl and the like. Examples of the alicyclic monoisocyanate compound include cyclopropyl isocyanate, cyclobutyl isocyanate, cyclopentyl isocyanate, cyclohexyl isocyanate, cycloheptyl isocyanate, cyclooctyl isocyanate and the like, with preference given to cyclohexyl isocyanate.

The aromatic moiety of the aromatic monoisocyanate compound in the present invention is preferably benzene, naphthalene and the like, more preferably benzene. Two or more aromatic moieties may be included, wherein they are bonded via linear or branched chain alkylene preferably having 1-10 carbon atoms (particularly preferably methylene). The aromatic moiety is optionally substituted by one or more substituents as long as the substitution does not impair the object of the present invention. Examples of the substituent include linear or branched chain alkyl having preferably 6-20, more preferably 6-12, carbon atoms, alkylene having preferably 1-26, more preferably 1-12, carbon atoms, and the like. Examples of the aromatic monoisocyanate compound include phenyl isocyanate, naphthalene isocyanate, hexylphenyl isocyanate, heptylphenyl isocyanate, octylphenyl isocyanate, nonylphenyl isocyanate, decylphenyl isocyanate, undecylphenyl isocyanate, dodecylphenyl isocyanate, benzyl isocyanate, phenetyl isocyanate, 4,4′-diphenylmethylene isocyanate and the like, with preference given to benzyl isocyanate.

The diisocyanate compound in the present invention may be, for example, an aliphatic diisocyanate compound, an alicyclic diisocyanate compound, an aromatic diisocyanate compound and the like, with preference given to aliphatic diisocyanate.

The aliphatic moiety of the aliphatic diisocyanate compound in the present invention is linear or branched chain saturated hydrocarbon group having preferably 1-20, more preferably 6-10, carbon atoms. The aliphatic moiety is optionally substituted by one or more substituents as long as the substitution does not impair the object of the present invention. Examples of the substituent include mono or polyvalent group derived from isophorone, methylenebis(cyclohexane) and the like, carboxyl group and the like. Examples of the aliphatic diisocyanate compound include trimethylene dilsocyanate, tetramethylene diisocyanate, hexamethylene diisocyanate, pentamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate, 2,6-bis(isocyanatomethyl)hexanoic acid and the like, with preference given to hexamethylene diisocyanate.

The alicyclic moiety of the alicyclic diisocyanate compound in the present invention is saturated or unsaturated alicyclic hydrocarbon group having preferably 3-20, more preferably 6-10, carbon atoms. Two or more unsaturated alicyclic hydrocarbon groups may be present, in which case they are bonded via linear or branched chain alkylene having preferably 1-12, more preferably 6-10, carbon atoms. The alicyclic moiety is optionally substituted by one or more substituents as long as the substitution does not impair the object of the present invention. Examples of the substituent include linear or branched chain alkyl, having preferably 4-12, more preferably 6-10, carbon atoms and the like. Examples of the alicyclic diisocyanate compound include 1,3-cyclopentene diisocyanate, 1,4-cyclohexane diisocyanate, 1,3-cyclohexane diisocyanate, 1,3-bis(isocyanatomethyl)-3,3,5-trimethylcyclohexane, 4,4′-methylenebis(cyclohexyl isocyanate), 2,4-cyclohexane diisocyanate, 1,3-bis(isocyanatomethyl)cyclohexane, 1,4-bis(isocyanatomethyl)cyclohexane, and the like, with preference given to 1,4-cyclohexane diisocyanate.

The aromatic moiety of aromatic diisocyanate compound in the present invention is preferably benzene or naphthalene, more preferably naphthalene. Two or more aromatic rings may be included, wherein each is bonded via a single bond, linear or branched chain alkylene having preferably 1-20, more preferably 6-12, carbon atoms or an oxygen atom and the like. The aromatic moiety is optionally substituted by one or more substituents as long as the object of the present invention is not impaired. Examples of the substituent include linear or branched chain alkyl having preferably 2-20, more preferably 6-12, carbon atoms, amino and the like. Examples of aromatic diisocyanate compound include m-phenylene diisocyanate, p-phenylene diisocyanate, 4,4′-biphenyl diisocyanate, 1,5-naphthalene diisocyanate, 4,4′-diphenylmethane diisocyanate, 2,4- or 2,6-tolylene diisocyanate, 4,4′-diphenyl ether diisocyanate, isophorone diisocyanate, 1,6-hexane diisocyanate; 1,3- or 1,4-xylylene diisocyanate, a mixture of 1,3-xylylene diisocyanate and 1,4-xylylene diisocyanate, ω,ω′-diisocyanato-1,4-diethylbenzene, 1,3- or 1,4-bis(1-isocyanato-1-methylethyl)benzene and a mixture of 1,3-bis(1-isocyanato-1-methylethyl)benzene and 1,4-bis(1-isocyanato-1-methylethyl)benzene and the like, with preference given to 4,4′-diphenylmethane diisocyanate and 1,6-hexane diisocyanate.

The polyisocyanate compound in the present invention may be, for example, aliphatic polyisocyanate compound, alicyclic polyisocyanate compound, aromatic polyisocyanate compound and the like, with preference given to aliphatic polyisocyanate. of the polyisocyanate compounds, one having not less than 3 isocyanato groups is particularly preferable.

The aliphatic moiety of aliphatic polyisocyanate compound in the present invention is linear or branched chain saturated hydrocarbon group having preferably 1-20, more preferably 6-10, carbon atoms, which is optionally substituted by one or more substituents as long as the object of the present invention is not impaired. Examples of the substituent include monovalent or polyvalent groups derived from isophorone, cyclohexane and the like. Examples of aliphatic polyisocyanate compound include 1,4,8-triisocyanatooctane, 1,6,11-triisocyanatoundecane, 1,8-diisocyanato-4-isocyanatomethyloctane, 1,3,6-triisocyanatohexane, 2,5,7-trimethyl-1,8-diisocyanato-5-isocyanatomethyloctane and the like.

The alicyclic moiety of alicyclic polyisocyanate compound in the present invention is saturated alicyclic hydrocarbon group having preferably 3-20, more preferably 3-10, carbon atoms, wherein two or more saturated alicyclic hydrocarbons may form a fused ring. Alternatively, two or more alicyclic hydrocarbon groups may be bonded to each other via single bond or a methylene group. The alicyclic moiety is optionally substituted by one or more substituents as long as the object of the present invention is not impaired. Examples of the substituent include linear or branched chain alkyl having preferably 4-12, more preferably 6-10, carbon atoms, linear or branched chain alkylene having preferably 4-12 carbon atoms, and the like. Examples of alicyclic polyisocyanate compound include

1,3,5-triisocyanatocyclohexane,

1,3,5-tris(isocyanatomethyl)cyclohexane,

2-(3-isocyanatopropyl)-2,5-di(isocyanatomethyl)bicyclo-[2.2.1]heptane,

2-(3-isocyanatopropyl)-2,6-di(isocyanatomethyl)bicyclo-[2.2.1]heptane,

3-(3-isocyanatopropyl)-2,5-di(isocyanatomethyl)bicyclo-[2.2.1]heptane,

5-(2-isocyanatoethyl)-2-(isocyanatomethyl)-3-(3-isocyanatopropyl)bicyclo[2.2.1]heptane,

6-(2-isocyanatoethyl)-2-(isocyanatomethyl)-3-(3-isocyanatopropyl)bicyclo[2.2.1]heptane,

5-(2-isocyanatoethyl)-2-(isocyanatomethyl)-2-(3-isocyanatopropyl)bicyclo[2.2.1]heptane,

6-(2-isocyanatoethyl)-2-(isocyanatomethyl)-2-(3-isocyanatopropyl)bicyclo[2.2.1]heptane and the like, with preference given to 1,3,5-tris(isocyanatomethyl cyclohexane.

The aromatic moiety of aromatic polyisocyanate compound in the present invention is preferably benzene, naphthalene and the like, more preferably naphthalene, wherein two or more of aromatic rings may be included. In this case, each ring may be bonded via a single bond, linear or branched chain alkylene having preferably 2-20, more preferably 6-12, carbon atoms, and the like. The aromatic moiety is optionally substituted by one or more substituents as long as the object of the present invention is not impaired. Examples of the substituent include linear or branched chain alkyl having preferably 2-20, more preferably 6-12, carbon atoms, linear or branched chain alkylene having preferably 2-20 carbon atoms, and the like. Examples of aromatic polyisocyanate compound include 1,3-bis(α,α-dimethylisocyanatomethyl)benzene, triphenylmethane-4,4″,4″-triisocyanate, 1,3,5-triisocyanatobenzene, 2,4,6-triisocyanatotoluene, 4,4′-diphenylmethane-2,2′,5,5′-tetraisocyanate and the like; 1,3,5-triisocyanatomethylbenzene and the like, with preference given to 1,3-bis(α,α-dimethylisocyanatomethyl)benzene.

The unsaturated urethane(meth)acrylate resin compound of the present invention can contain one or more of the above-mentioned isocyanate compounds in combination. Further, biuret compounds, isocyanurate compounds, adducts obtained by urethane reaction of various polyhydroxy compounds, allophanate compounds, oxadiazinetrione compounds and uretidione compound, which are the denatured compounds from one or more of the above-mentioned isocyanate compound, can be used as the isocyanate compound in the present invention. Of these, isocyanurate compounds are particularly preferable, such as tris(isocyanatoalkyl) -substituted isocyanurate compound. The alkyl moiety of tris(isocyanatoalkyl)-substituted isocyanurate compound includes linear or branched chain alkyl having 2-20, preferably 2-10, carbon atoms, such as ethyl, butyl, hexyl and the like. Particularly preferable tris(isocyanatoalkyl)-substituted isocyanurate compound is tris(6-isocyanatohexyl) isocyanurate.

Examples of hydroxyl compound having a (meth)acryloyl group in a molecule in the present invention include hydroxyalkyl (meth)acrylate, hydroxycycloalkyl (meth)acrylate, polyalkylene glycol mono(meth)acrylate, adduct of glycidyl (meth)acrylate and (meth)acrylic acid, ring-opening reaction product of these (meth)acrylate compounds and ε-caprolactone, adduct of glycidyl ether and (meth)acrylic acid, adduct of phenyl glycidyl ether and (meth)acrylic acid and the like, with preference given to hydroxyalkyl (meth)acrylate and polyalkylene glycol mono(meth)acrylate. The hydroxyl compounds having (meth)acryloyl in a molecule can be used alone or in combination of two or more of these.

The alkyl moiety of hydroxyalkyl (meth)acrylate in the present invention is linear or branched chain alkyl having preferably 2-100, more preferably 2-60, carbon atoms, which is optionally substituted as long as the object of the present invention is not impaired. Examples of the substituent include phenoxy, groups derived from caprolactam denatured diol, and the like. The hydroxyalkyl (meth)acrylate may contain one or more (meth)acryloyl groups in a molecule. Examples of hydroxyalkyl (meth)acrylate include mono(meth)acrylate such as 2-hydroxyethyl (meth)acrylate, 2-hydroxypropyl (meth)acrylate, 2-hydroxybutyl (meth)acrylate, 3-hydroxybutyl (meth)acrylate, 4-hydroxybutyl (meth) acrylate, 2-hydroxy-3-phenoxypropyl (meth)acrylate and the like; di(meth)acrylate such as trimethylolpropane di(meth)acrylate, trimethylolethane di(meth)acrylate, glycidol dimethacrylate and the like; pentaerythritol tri(meth)acrylate, dipentaerythritol hexa(meth)acrylate and the like, with preference given to pentaerythritol tri(meth)acrylate.

The cycloalkyl moiety of hydroxycycloalkyl (meth)acrylate in the present invention is cycloalkyl having preferably 3-30, more preferably 4-20, carbon atoms, which is optionally substituted as long as the object of the present invention is not impaired. Examples of the substituent include methyl, ethyl, and a group derived from ethoxylated bisphenol. The hydroxycycloalkyl (meth)acrylate may contain one or more (meth)acryloyl groups in a molecule. Examples of hydroxycycloalkyl (meth)acrylate include cyclohexanedimethanol mono(meth)acrylate, cycloheptanedimethanol mono(meth)acrylate, cyclooctanedimethanol mono(meth)acrylate, caprolactam denatured mono(meth)acrylate, spiroglycol denatured mono(meth)acrylate and the like, with preference given to cyclohexanedimethanol mono (meth) acrylate.

The alkyl moiety of polyalkylene glycol mono(meth)acrylate in the present invention is linear or branched chain alkyl having 1-100, preferably 2-60, carbon atoms, wherein each alkyl moiety may be bonded via an oxygen atom. The polyalkylene glycol mono(meth)acrylate may contain one or more (meth)acryloyl groups in a molecule. Examples of polyalkylene glycol mono(meth)acrylate include mono(meth)acrylate such as polyethylene glycol mono(meth) acrylate, polypropylene glycol mono(meth ) acrylate, poly(tetramethyleneoxido mono(meth)acrylate) and the like, and adduct of (meth)acrylic acid and ethylene-propylene glycol block polymer, with preference given to polyethylene glycol mono(meth)acrylate.

It is also possible to concurrently use various polyhydroxyl-containing compounds in urethane reaction of isocyanate compound and a hydroxyl compound having a (meth)acryloyl group in a molecule. The use of a polyhydroxyl-containing compound is preferable because it improves water dispersibility and water emulsifiability of the coating composition, and suppresses the warp of the coating object (floor, floor material, plastic film and the like). The polyhydroxyl-containing compound can be used for the production method of the urethane(meth)acrylate resin as in the following. First, the polyhydroxyl-containing compound is preliminarily reacted with an excess isocyanate compound to synthesize a prepolymer having an isocyanate terminal. Then, this prepolymer is reacted with a hydroxyl compound having a (meth)acryloyl group in a molecule to produce the urethane(meth)acrylate resin. These reactions can be carried out concurrently.

Examples of the polyhydroxyl-containing compound include alkylene glycol, polyhydroxyl-containing carboxylic acid and derivatives thereof (e.g., hydroxypivalic acid neopentyl glycol ester, dimethylolpropionic acid, dimethylolbutanoic acid and the like), polyhydroxyl-containing alicyclic compound (e.g., cyclohexanedimethylol, 1,4-cyclohexanediol, spiroglycol (e.g., 3,9-bis(1,1-dimethyl-2-hydroxyethyl)-2,4,8,10-tetraoxaspiro[5.5]undecane and the like), tricyclo[5.2.1.0]decane-4,8-dimethanol, 2,2,6,6-tetramethylolcyclohexanol-1, inositol and the like), bisphenol compound and adduct of alkylene oxide and bisphenol compound (e.g., hydrogenated bisphenol A, adduct of ethylene oxide and bisphenol A, adduct of propylene oxide and bisphenol A, adduct of hydroxyethylene oxide and bisphenol A, adduct of ethoxy and bisphenol S and the like), polyhydroxyl-containing aliphatic compound (e.g., trimethylolethane, trimethylolpropane, ditrimethylolethane, ditrimethylolpropane, glycerin, diglycerol, 3-methylpentane-1,3,5-triol, pentaerythritol, dipentaerythritol, tripentaerythritol, mannitol, sorbitol and the like), isocyanurate compound (e.g., tris(2-hydroxyethyl)isocyanurate and the like), glucose (e.g., hydroxypropylmethylcellulose phthalate, hydroxypropylmethylcellulose acetate and the like); polyester polyol, polyether polyol, polycarbonate polyol (preferably polyester polyol) and the like, particularly preferably dipentaerythritol. These can be used alone or in combination of two or more compounds thereof.

The alkylene moiety of alkylene glycol of the above-mentioned polyhydroxyl-containing compound is linear or branched chain alkylene having 2-100, preferably 2-60, carbon atoms, which is optionally substituted by one or more substituents, such as halogen atom, —SH, —SR (wherein R is alkyl which is preferably alkyl having 2-12 carbon atoms) and the like. Examples of alkylene glycol include ethylene glycol, 1,3-propylene glycol, 1,2-propylene glycol, diethylene glycol, dipropylene glycol, neopentyl glycol, 1,3-butanediol, 1,4-butanediol, 1,6-hexanediol, 1,9-nonanediol, 1,10-decanediol, 2,2,4-trimethyl-1,3-pentanediol, 3-methyl-1,5-pentanediol, dichloroneopentyl glycol, dibromoneopentyl glycol and the like, with preference given to ethylene glycol and dipropylene glycol.

An aliphatic and/or alicyclic urethane(meth)acrylate resin obtained by the above-mentioned method, which shows less discoloring is preferable for floors.

2-2. Photopolymerization Initiator

The photopolymerization initiator is not subject to any particularly limitation as long as it absorbs light and produces radical or cation, with preference given to one that strongly absorbs ultraviolet light having a wavelength that a low-pressure mercury lamp releases It may be used in combination with a generally known photosensitizer that absorbs ultraviolet light near 254 nm.

As the photopolymerization initiator, for example, benzoyl (e.g., 1-hydroxycyclohexylphenylketone, 2-methyl-1-[4-(methylthio)phenyl]-2-morpholinopropane-1-one, 2-hydroxy-2-methyl-1-phenylpropane-1-one, 2-benzyl-2-dimethylamino-1-(4-morpholinophenyl)-butane-1-one, 1-[4-(2-hydroxyethoxy)-phenyl]-2-hydroxy-2-methyl-1-propane-1-one, 1-(4-isopropylphenyl)-2-hydroxy-2-methylpropane-1-one, 4′-isopropyl-2-hydroxy-2-methylpropiophenone and the like), phosphine oxide (e.g., bisacylphosphine oxide, acylphosphine oxide, 2,4,6-trimethylbenzoyldiphenylphosphine oxide, 2,6-dimethylbenzoyldiphenylphosphine oxide, benzoyldiethoxyphosphine oxide, bis(2,6-dimethoxybenzoyl)-2,4,4-trimethylpentylphosphine oxide and the like), benzoin (e.g., benzoin methyl ether, benzoin ethyl ether, benzoin isopropyl ether, benzoin isobutyl ether, n-butyl benzoin ether and the like), acetophenone (e.g., p-tert-butyltrichloroacetophenone, p-tert-butyldichloroacetophenone, acetophenone, 2,2-diethoxyacetophenone, chlorinated acetophenone, hydroxyacetophenone, α,α-dichloro-4-phenoxyacetophenone and the like), benzophenone (e.g., benzophenone, 4,4′-dichlorobenzophenone, 4,4′-bis(dimethylamino) benzophenone, 4,4′-bis(diethylamino)-benzophenone, 3,3′,4,4′-tetra(tert-butylperoxycarbonyl)-benzophenone, 3,3′-dimethyl-4-methoxybenzophenone and the like), thioxanthone (e.g. 2-chloro-thioxanthone, 2-methyl-thioxanthone, 2,4-diethyl-thioxanthone, 2,4-diisopropyl-thioxanthone and the like), anthraquinone (e.g., anthraquinone, 2-ethylanthraquinone, α-chloroanthraquinone, 2-tert-butylanthraquinone and the like), benzyl (e.g., benzyl, 4,4′-dimethoxybenzil, 4,4′-dichlorobenzil and the like), benzoic acid ester (e.g., methyl o-benzoylbenzoate, methyl p-dimethylaminobenzoate and the like), diketone (e.g., biacetyl, methyl phenylglyoxylate, methyl benzoylformate and the like), ketal (e.g., benzyl dimethyl ketal, acetophenone diethyl ketal and the like), dibenzocycloalkanone (e.g., 10-butyl-2-chloroacridone, dibenzosuberon and the like), acyl oxime ester, camphorquinone, 3-ketocumarin, tetramethyl thiuram disulfide, α,α′-azobisisobutyronitrile, benzoylperoxide, 2,2′-bis(o-chlorophenyl)-4,5,4′,5′-tetraphenyl-1,2′-biimidazole, acenaphthene, benzal acetone and the like are included.

The amount of the photopolymerization initiator to be used in the present invention is generally 0.01-20 wt %, preferably 0.1-10 wt %, of the photopolymerizable resin. 2-3. Other components

The ultraviolet curable coating agent of the present invention may contain generally known reactive diluent other than the required component.

The above-mentioned reactive diluent includes a reactive diluent having one unsaturated bond, a reactive diluent having two unsaturated bonds, a reactive diluent having not less than 3 unsaturated bonds and the like. These reactive diluents can be used alone or in combination of plural kinds thereof.

The amount of the reactive diluent to be used is generally preferably not more than 400 parts by weight, more preferably not more than 100 parts by weight, per 100 parts by weight of the photopolymerizable resin. When the concentration of the reactive diluent exceeds 400 parts by weight, the stain resistance, abrasion resistance, chemical resistance and weatherability of the cured coating film may be degraded.

As the reactive diluent having one unsaturated bond, for example, (meth)acrylic acid, alkyl (meth)acrylate, dialkylaminoalkyl (meth)acrylate, glycidyl (meth)acrylate, carbitol (meth)acrylate, isobornyl (meth)acrylate, acryloyl morpholine and the like are mentioned.

The alkyl moiety of the above-mentioned alkyl (meth)acrylate is linear or branched alkyl preferably having 1-20, more preferably 2-10, carbon atoms, which is optionally substituted by one or more such as hydroxy group, phenoxy group, glycidyl group, carboxyl group and the like. As alkyl (meth)acrylate, for example, methyl (meth)acrylate, ethyl (meth)acrylate, butyl (meth)acrylate, hexyl (meth)acrylate, 2-ethylhexyl (meth)acrylate, isooctyl (meth)acrylate, 2-hydroxyethyl (meth)acrylate, 2-hydroxypropyl (meth)acrylate, 2-hydroxy-3-phenoxypropyl (meth)acrylate and the like are mentioned, with preference given to 2-hydroxyethyl (meth)acrylate.

The alkyl moiety of the above-mentioned dialkylaminoalkyl (meth)acrylate is linear or branched alkyl preferably having 1-20, more preferably 2-8, carbon atoms. The alkyl of the dialkyl moiety are the same or different and each is independently linear or branched alkyl preferably having 1-20, more preferably 2-8, carbon atoms. Examples of dialkylaminoalkyl (meth)acrylate include N,N-dimethylaminoethyl (meth) acrylate, N,N-diethylaminoethyl (meth)acrylate and the like, with preference given to N,N-diethylaminoethyl (meth ) acrylate.

As the reactive diluent having two unsaturated bonds, for example, alkanediol di(meth)acrylate, polyalkylene glycol di(meth)acrylate and the like are mentioned.

The alkane moiety of the above-mentioned alkanediol di(meth)acrylate is linear, branched or cyclic hydrocarbon preferably having 1-20, more preferably 2-8, carbon atoms, which is optionally substituted by one or more of hydroxy group and phenoxy group. Examples of alkanediol di(meth)acrylate include 1,6-hexanediol di(meth)acrylate, neopentylglycol di(meth)acrylate, ethylene glycol di(meth)acrylate, butylene glycol di(meth)acrylate, pentaerythritol di(meth)acrylate and 1,4-butanediol di(meth)acrylate.

The alkylene of the above-mentioned polyalkylene glycol di(meth)acrylate is linear or branched alkylene preferably having 1-20, more preferably 2-10, carbon atoms. Examples of polyalkylene glycol di(meth)acrylate include polyethylene glycol di(meth)acrylate, polypropylene glycol di(meth)acrylate, caprolactam denatured di(meth)acrylate and the like, with preference given to polyethylene glycol di(meth)acrylate.

The reactive diluent having 3 or more unsaturated bonds include, for example, trimethylolpropane tri(meth)acrylate, pentaerythritol tri(meth)acrylate, dipentaerythritol hexa(meth)acrylate, tetramethylolmethane tetra(meth)acrylate, acrylic acid ester of N,N,N′,N′-tetrakis(β-hydroxyethyl)-ethyldiamine and the like.

The reactive diluent when the unsaturated bond of the unsaturated urethane compound is derived from allyl group is exemplified by diallyl phthalate, diallyl isophthalate, diallyl adipate and the like.

The reactive diluent when the unsaturated bond of unsaturated urethane compound is derived from vinyl group includes, for example, styrene, acrylonitrile, vinyl acetate, vinyltoluene, N-vinylpyrrolidone and the like.

The ultraviolet curable coating agent in the present invention may contain generally used additives as long as the object of the present invention is not impaired. For example, coloring agent, pigment, flat agent, anti-forming agent, deforming agent, wetting agent, leveling agent, antistatic agent, viscosity controlling agent, storing stabilizer, antibacterial agent, preservative, antislip agent, coating film crack inhibitor, adhesion promoter, dispersant, surfactant, extender pigment, mold release agent, silane coupling agent, stabilizer, fire retardant and the like can be used.

3. Substrate

The substrate in the present invention is not particularly limited and exemplified by vinyl chloride material, polyester decorative laminate, melamine decorative laminate, wood, stone, ceramic, plastic, metal, paper, cloth and the like.

4. Primer

The ultraviolet curable coating agent in the present invention may be directly applied to a substrate, or applied on a primer layer after coating a suitable primer on a substrate. When cured with an ultraviolet irradiation apparatus of the present invention wherein the light source is a low-pressure mercury lamp, the latter shows superior adhesiveness between substrate and coating film after curing. It is therefore more preferable to apply an ultraviolet curable coating agent after applying a primer to a substrate than to directly apply the ultraviolet curable coating agent to a substrate.

The primer layer in the present invention is formed between an ultraviolet curable coating agent layer and a substrate for various objects, and the kind of the primer is appropriately varied depending on the object. For example, for enhanced adhesiveness between an ultraviolet curable coating agent and a substrate, for inhibition of permeation of an ultraviolet curable coating agent through a substrate and for protection of a substrate, a primer layer is formed. A primer having the necessary property is applied in a suitable amount to a substrate. The primer layer may include as many layers as desired, which is preferably 1 or 2 layers in view of the work efficiency.

The primer in the present invention is not particularly limited, as long as it does not impair the object of the prevent invention. For example, natural and synthetic polymers are mentioned, such as polyurethane resin, acryl resin, unsaturated polyester resin, epoxy resin, acrylsilicone resin, fluorine contained resin, alkyd resin, urea resin, melamine resin, acetic acid vinyl resin, cellulose resin (e.g., nitrocellulose, cellulose acetate butyrate and the like), fats and oil (e.g., rosin derivative, linseed oil, tung oil, soybean oil, castor oil and the like) and the like. Because light irradiation does not easily cause discoloration or degradation, polyurethane resin and acryl resin are preferable.

The primer of the present invention may contain generally used additives as long as the object of the present invention is not impaired. For example, sensitizing agent, coloring agent, anti-forming agent, deforming agent, wetting agent, leveling agent, antistatic agent, viscosity controlling agent, storing stabilizer, antibacterial agent, preservative, antislip agent, coating film crack inhibitor, adhesion promoter, dispersant, surfactant, extender pigment, mold release agent, silane coupling agent, stabilizer, fire retardant and the like are included, which can be used alone or in combination of two or more thereof.

The primer of the present invention can take various forms such as organic solvent form (e.g., organic solvent such as ethyl acetate, butyl acetate, methanol, ethanol, isopropyl alcohol, mineral spirit and the like), non-solvent form, aqueous form (use water as solvent, for example, aqueous solution, aqueous emulsion, aqueous dispersion and the like). In the case of aqueous form, solvent evaporation does not produce odor or toxic gas during drying and is preferable environmentally and for the health of painter. In addition, since an organic solvent for washing is not necessary, aqueous form is preferable for worksite application. A primer in an aqueous form generally has low viscosity and is suitable for a simple and easy coating method using brush, roller, mouton, mop, spraying and the like.

5. Method of Forming Cured Coating Film

The cured coating film of the present invention can be formed as follows.

The above-mentioned ultraviolet curable coating agent (preferably ultraviolet curable coating agent containing photopolymerizable resin containing urethane(meth)acrylate resin) is applied to a substrate and, using the ultraviolet irradiation apparatus of the present invention, exposed to ultraviolet light to cure the coating film, whereby a cured coating film can be formed. Where necessary, a primer can be applied before coating of a substrate with an ultraviolet curable coating agent.

The ultraviolet curable coating agent of the present invention can be applied to a substrate without using a solvent. For appropriate application, however, an organic solvent, water and the like may be added. Examples of the organic solvent include aromatic solvent such as xylene and toluene, ester solvent such as ethyl acetate and butyl acetate, alcohol solvent such as methanol and ethanol and the like. When water is used as a solvent, application form is not limited, and, for example, emulsion, molecular dispersion, dispersion and the like can be mentioned. Considering the health of the worker and burden on the environment, the use of water as a solvent is preferable.

The ultraviolet curable coating agent is applied to make the lower limit of the film thickness after curing by UV irradiation preferably not less than 4 μm, more preferably not less than 7 μm, and the upper limit of the film thickness after curing by UV irradiation less than 75 μm, preferably not more than 70 μm by a generally known method. When the film thickness after curing is less than 4 μm, the desired gloss of the cured coating film is not achieved. A film thickness of not less than 75 μm is not preferable, because sufficient curing takes too long, necessitating slow move of the ultraviolet irradiation apparatus and causing poor workability. In this case, cure-shrinkage of the aforementioned coating agent easily causes warp, breaking and the like of the substrate forming the cured coating film.

The ultraviolet curable coating agent can be applied to a substrate by a known method. For example, air-spray, airless-spray, brush, roller and the like can be employed.

The primer of the present invention can be applied to a substrate by a method similar to the method employed for application of the above-mentioned ultraviolet curable coating agent to a substrate.

The ultraviolet curable coating agent can be applied to a primer layer by a method similar to the method employed for application to a substrate, but it should follow drying of the primer layer. Drying is done according to a conventionally known method (e.g., air drying, hot air drying, light irradiation and the like).

According to the present invention, after UV irradiation, the resulting UV insufficient area is subjected to UV irradiation again within a specific amount of time to prevent occurrence of defects of coating film, such as Tortoiseshell Pattern, Wrinkle, Fog and the like. UV irradiation to a UV insufficient area may be conducted several times, and UV irradiation can be applied to a coating film having a UV insufficient area The “coating film having UV insufficient area” means, for example, a coating film consisting of UV insufficient area or a coating film consisting of UV insufficient area and UV irradiation area and/or UV unirradiation area. UV irradiation to a coating film having a UV insufficient area is done preferably within 15 minutes, more preferably within 5 minutes, particularly preferably within 2 minutes, from the previous UV irradiation.

When an ultraviolet curable coating agent is cured using an ultraviolet irradiation apparatus, UV irradiation quantity during curing is generally not less than 60 mJ/cm² and not more than 10000 mJ/cm², preferably not less than 150 mJ/cM² and not more than 3000 mJ/cm². When the UV irradiation quantity is less than 60 mJ/cm², the coating film takes time to cure, and when it exceeds 10000 mJ/cm² the substrate and coating film are adversely influenced to show discoloring and the like.

The ultraviolet irradiation apparatus and the method of forming a cured coating film of the present invention can be applied at any place, as long as the above-mentioned substrate of the present invention is used, for example, wall, floor, table, chairs and the like, and in a worksite, it is particularly preferably used for a floor surface.

For example, an ultraviolet curable coating agent is applied to a floor surface, and, using a moveable ultraviolet irradiation apparatus, ultraviolet light is irradiated to cure the coating film, whereby a cured coating film is formed. In addition, by using the moveable ultraviolet irradiation apparatus of the present invention, a coating can be applied to a substrate without a burn or thermal deformation, even when the substrate is a floor material made from a resin having low heat resistance, such as vinyl chloride resin, polyolefin resin, polyester resin and the like.

### EXAMPLES

The present invention is explained in more detail in the following by referring to Examples that do not limit the present invention in any way. In the following Examples and Comparative Examples, “part(s)” means “part(s) by weight” unless particularly indicated.

### Example 1

An aqueous emulsion type urethaneacrylate resin (100 parts, Arakawa Chemical Industries, Ltd.: EM-92) and photopolymerization initiator (1 part, Ciba Specialty Chemicals: Darocur 0.1173) were mixed uniformly in a stirrer and to give an ultraviolet curable coating agent (A). This was applied on a polyester decorative laminate in such a manner that the film thickness after curing became 50 μm and dried at ambient temperature for 130 minutes.

### Example 2

An urethaneacrylate resin (50 parts, DAINIPPON INK AND CHEMTCALS, INCORPORATED: UNIDIC 17-806), photopolymerization initiator (0.8 part, Ciba Specialty Chemicals; Darocur 1173) and ethyl acetate (30 parts) were mixed uniformly in a stirrer to give an ultraviolet curable coating agent (B). This was applied on a polyester decorative laminate in such a manner that the film thickness after curing became 50 μm and dried at ambient temperature for 30 minutes.

### Example 3

A urethaneacrylate resin (50 parts, SHIN-NAKAMURA CHEMICAL CO., LTD.: U-15RA), a photopolymerization initiator (1 part, Ciba Specialty Chemicals: Darocur 1173) and ethyl acetate (50 parts) were mixed uniformly in a stirrer to give an ultraviolet curable coating agent (C). This was applied on a polyester decorative laminate in such a manner that the film thickness after curing became 50 μm and dried at ambient temperature for 30 minutes.

### Example 4

A urethaneacrylate resin (6.3 parts, DAINIPPON INK AND CHEMICALS, INCORPORATED: UNIDIC 17-806), an epoxy acrylate resin (45 parts, DAICEL UCB COMPANY LTD.: EB-3404), a photopolymerization initiator (0.5 part, Ciba Specialty Chemicals: Darocur 1173) and ethyl acetate (46 parts) were mixed uniformly in a stirrer to give an ultraviolet curable coating agent (D). This was applied on a polyester decorative laminate in such a manner that the film thickness after curing became 50 μm and dried at ambient temperature for 1 hour.

### Example 5

An aqueous emulsion type top coating ultraviolet curable coating agent (urethaneacrylate resin content 80%, GEN Maintenance Technology Inc.: winup Topcoat T, catalyst:DBTDL) (E) was applied on a composition vinyl chloride floor material coated with primer (GEN Maintenance Technology Inc.: winup Undercoat U) in such a manner that the film thickness after curing became 20 μm and dried at ambient temperature for 1 hour.

### Example 6

An aqueous emulsion type urethaneacrylate resin (100 parts, Arakawa Chemical Industries, Ltd.: EM-92) and a photopolymerization initiator (1 part, Ciba Specialty-Chemicals: Darocur 1173) were mixed uniformly in a stirrer to give an ultraviolet curable coating agent (A). This was applied on a polyester decorative laminate in such a manner that the film thickness after curing became 50 μm and dried at ambient temperature for 1 hour.

### Comparative Example 1

An unsaturated polyester resin (50 parts, NIPPON KAYAKU CO., LTD.: PAR-500), a photopolymerization initiator (1 part, Ciba Specialty Chemicals: Darocur 1173) and ethyl acetate (50 parts) were mixed uniformly in a stirrer to give an ultraviolet curable coating agent (F). This was applied on a polyester decorative laminate in such a manner that the film thickness after curing became 50 μm and dried at ambient temperature for 30 minutes.

### Comparative Example 2

An epoxy acrylate resin (50 parts, DAICEL UCB COMPANY LTD.: EB-3404), a photopolymerization initiator (1 part, Ciba specialty Chemicals: Darocur 1173) and ethyl acetate (50 parts) were mixed uniformly in a stirrer to give an ultraviolet curable coating agent (G). This was applied on a polyester decorative laminate in such a manner that the film thickness after curing became 50 μm and dried at ambient temperature for 30 minutes.

The coating films made from the ultraviolet curable coating agents obtained in the above-mentioned Examples and Comparative Examples were cured using a moveable ultraviolet irradiation apparatus (EYEGRAPHICS Co., Ltd.: W-100) with a low-pressure mercury lamp and a moveable ultraviolet irradiation apparatus (EYEGRAPHICS Co., Ltd.: L-100) with a high-pressure mercury lamp, by UV irradiation for 5 seconds. UV irradiation quantity for curing using each irradiation apparatus was 150 mJ/cm² for low-pressure mercury lamp, and 600 mJ/cm² for high-pressure mercury lamp.

Coating Film Property Test

After curing, the coating films of Examples 1-6 and Comparative Examples 1-2, they were subjected to 3 hour spotting using aqueous red ink (PILOT CORPORATION: ink red) and oil-based black ink. The part spotted with aqueous red ink was washed with water and the part spotted with oil-based black ink was wiped with petroleum benzin. The extent of stain left on the coating film was visually observed. The cured coating film of Example 5 was subjected to evaluation of adhesiveness by crosscut cellotape (registered trademark) peeling method. The results are shown in Table 1.

Evaluation Criteria

∘: the same level of coating film property between curing with a low-pressure mercury lamp and curing with a high-pressure mercury lamp.

×: inferior coating film property of curing with a low-pressure mercury lamp than curing with a high-pressure mercury lamp.

TABLE 1

| | | | | | | | Comparative | |
|---|---|---|---|---|---|---|---|---|
| | Examples | | | | | | Examples | |
| | 1 | 2 | 3 | 4 | 5 | 6 | 1 | 2 |
| aqueous red | ◯ | ◯ | ◯ | ◯ | ◯ | ◯ | X | X |
| ink | | | | | | | | |
| oil-based | ◯ | ◯ | ◯ | ◯ | ◯ | ◯ | X | X |
| black ink | | | | | | | | |
| adhesiveness | — | — | — | — | ◯ | — | — | — |

### Example 7

A coating film made from an ultraviolet curable coating agent obtained in Example 5 was subjected to UV irradiation using a moveable ultraviolet irradiation apparatus (EYEGRAPHICS Co., Ltd.: W-100) with a low-pressure mercury lamp for 5 seconds. Immediately after first UV irradiation and after 2 minutes, 5 minutes, 15 minutes and 30 minutes from the completion of the first UV irradiation, ultraviolet light was irradiated again to UV insufficient areas and occurrence of Tortoiseshell Pattern, Wrinkle and Fog was visually observed and evaluated. The results are shown in Table 2.

Evaluation Criteria

∘∘: No occurrence of Tortoiseshell Pattern, Wrinkle or Fog by visual observation from about 10 cm from the film.

∘: No occurrence by visual observation from about 50 cm from the film, but occurrence of one of Tortoiseshell Pattern, Wrinkle and Fog was observed from 10 cm from the film.

Δ: Occurrence of one of Tortoiseshell Pattern, Wrinkle and Fog was visually observed from not less than 50 cm from the film.

×: occurrence of at least two of Tortoiseshell Pattern, Wrinkle and Fog was visually observed from not less than 50 cm from the film.

### Example 8

In the same manner as in Example 5 except that the urethane(meth)acrylate resin obtained by changing the catalyst used for urethane reaction to aluminum was used, the obtained coating film was subjected to UV irradiation using a moveable ultraviolet irradiation apparatus (EYEGRAPHICS Co., Ltd.: W-100) with a low-pressure mercury lamp for 5 seconds. Immediately after first UV irradiation and after 2 minutes, 5 minutes, 15 minutes and 30 minutes from the completion of the first UV irradiation, ultraviolet light was irradiated again to UV insufficient areas and occurrence of Tortoiseshell Pattern, Wrinkle and Fog was visually observed and evaluated in the same manner as in Example 7. The results are shown in Table 2.

TABLE 2

| | | Second irradiation (Time from first | | | |
|---|---|---|---|---|---|
| | First | irradiation) | | | |
| | Irradiation | 2 min | 5 min | 15 min | 30 min |
| Example 7 | ◯◯ | ◯◯ | ◯ | ◯ | X |
| Example 8 | ◯◯ | ◯◯ | ◯◯ | ◯◯ | Δ |

As is evident from the foregoing description, the present invention provides a moveable ultraviolet irradiation apparatus requiring an input power smaller than conventional ones, which can improve workability and safety and permits miniaturization and light-weight apparatus.

According to the method of the present invention, the problems associated with the use of an ultraviolet irradiation apparatus, whose light source is a high-pressure mercury lamp, can be solved, such as the need of a high voltage power source, degradation of quality, potential hazard to operators and the like, and a cured coating film having the same properties as achieved by the use of a high-pressure mercury lamp, as evidenced in stain resistance, adhesion to substrate and the like, and requiring a shorter time for curing of a unit area of the film as compared to the use of a high-pressure mercury lamp (100 V type) can be provided. Accordingly, the present invention is particularly useful for floor surfaces of gymnasiums, classrooms, department stores, offices, stores, showrooms and the like.

This application is based on application Nos. 2001-72686, 2001-79336, 2001-398486 and 2001-400816 filed in Japan, the contents of which are incorporated hereinto by reference.

What is claimed is:

1. An ultraviolet irradiation apparatus for curing an ultraviolet curable coating agent applied on a substrate by irradiating an ultraviolet light to the ultraviolet curable coating agent, comprising a low-pressure mercury lamp as a light source.

2. The ultraviolet irradiation apparatus of claim 1, which is moveable and which comprises a power source section equipped with a wheel, and a light source section electrically connected to the power source section that emits an ultraviolet light upon supply of electricity from the power source section.

3. The ultraviolet irradiation apparatus of claim 2, wherein the power source section is supplied with an input voltage of less than 200 V and an input current of not more than 20 A.

4. The ultraviolet irradiation apparatus of claim 2, wherein the low-pressure mercury lamp has an input power per unit size of not less than 1 W/cm.

5. The ultraviolet irradiation apparatus of claim 2, wherein the light source section and the power source section are electrically connected with a detachable electric cord.

6. The ultraviolet irradiation apparatus of claim 5, wherein the light source section can be placed on the power source section.

7. The ultraviolet irradiation apparatus of claim 2, which further comprises, in addition to said light source section comprising a low-pressure mercury lamp as a light source, a second light source section that emits an ultraviolet light having a dominant wavelength of not less than 320 nm as a light source, said second light source section is disposed such that the ultraviolet light having a wavelength of not less than 320 nm reaches the ultraviolet curable coating agent after arrival of the ultraviolet light from said low-pressure mercury lamp.

8. The ultraviolet irradiation apparatus of claim 7, wherein the ultraviolet light source having a dominant wavelength of not less than 320 nm is disposed on both sides of the light source section.

9. The ultraviolet irradiation apparatus of claim 7, wherein the light source having a dominant wavelength of not less than 320 nm is disposed at an upper side or in front of the low-pressure mercury lamp on a forward end of the light source section.

10. A method of forming a cured coating film, comprising the steps of
(a) coating a substrate with an ultraviolet curable coating agent comprising a photopolymerization initiator and a photopolymerizable resin comprising a urethane(meth)acrylate resin, and
(b) irradiating an ultraviolet light using the ultraviolet irradiation apparatus of claim 1, to cure the coating film.

11. The method of forming the cured coating film according to claim 10, wherein the urethane(meth)acrylate resin is produced by a urethane reaction using an aluminum compound as a catalyst.

12. The method of forming the cured coating film according to claim 10, wherein the ultraviolet curable coating agent is applied to a substrate such that the film has a thickness after curing of not less than 4 μm and not more than 70 μm.

13. The method of forming the cured coating film according to claim 10, wherein the ultraviolet curable coating agent is applied to a substrate such that the film has a thickness after curing of not less than 7 μm and not more than 70 μm.

14. The method of forming the cured coating film according to claim 10, wherein the ultraviolet curable coating agent is applied to a substrate after application of a primer thereto.

15. The method of forming the cured coating film according to claim 10, wherein the ultraviolet curable coating agent is aqueous.

16. The method of forming the cured coating film according to claim 10, wherein the ultraviolet curable coating agent is applied to a floor surface, after which the ultraviolet light is irradiated thereon using the ultraviolet irradiation apparatus of claim 2 to cure the coating agent.

17. The method of forming the cured coating film according to claim 10, further comprising plural times of UV irradiation of a coating film having a UV insufficient area produced by the UV irradiation, using a moveable ultraviolet irradiation apparatus.

18. The method of forming the cured coating film according to claim 17, wherein the UV irradiation is applied within 15minutes from a previous UV irradiation.

19. The method of forming the cured coating film according to claim 17, wherein the UV irradiation is applied within 5 minutes from a previous UV irradiation.

20. A urethane(meth)acrylate resin obtained by reacting an isocyanate compound and a hydroxyl compound using an aluminum compound as a catalyst.

21. A ultraviolet curable coating agent comprising the urethane(meth)acrylate resin of claim 20.
